(19) United States
(12) Patent Application Publication
(10) Pub. No.: US 2020/0185731 A1
(43) Pub. Date: Jun. 11, 2020

(54) FLEXIBLE SEALING STRUCTURE

(71) Applicant: Microcosm Technology Co., Ltd., Tainan City (TW)

(72) Inventors: Chun-Ting Yeh, Tainan City (TW); Sih-Ci Jheng, Tainan City (TW)

(73) Assignee: Microcosm Technology Co., Ltd., Tainan City (TW)

(21) Appl. No.: 16/698,963

(22) Filed: Nov. 28, 2019

(30) Foreign Application Priority Data
Dec. 6, 2018 (TW) 107143959

(51) Int. Cl. H01M 8/0276; H01M 8/1004

(52) U.S. Cl. CPC H01M 8/0278; H01M 8/1004

(57) ABSTRACT

A flexible sealing structure is provided. The flexible sealing structure includes a flexible sealing member and a membrane electrode assembly. The flexible sealing member includes a first flexible sealing film and a second flexible sealing film, and a hollow region is formed in a center of the flexible sealing member. The membrane electrode assembly is located between the first flexible sealing film and the second flexible sealing film. A side surface of the membrane electrode assembly is even. The membrane electrode assembly has a first surface and a second surface. The hollow region of the flexible sealing member exposes a portion of the first surface and a portion of the second surface of the membrane electrode assembly.

### CROSS-REFERENCE TO RELATED APPLICATION

This application claims the priority benefit of Taiwan application serial no. 107143959, filed on Dec. 6, 2018. The entirety of the above-mentioned patent application is hereby incorporated by reference herein and made a part of this specification.

### BACKGROUND OF THE INVENTION

### 1. Field of the Invention

The invention relates to a sealing structure, and in particular, to a flexible sealing structure.

### 2. Description of Related Art

A fuel cell is a device for generating current through reaction between hydrogen fuel gas and oxidizing agent gas by electrochemical stack-up. An electrolyte membrane as a core element in the fuel cell can be configured to provide high proton or ion conduction, block electrons, and block gas fuel passing at two ends. A sealing member in the fuel cell is configured to enhance mechanical performance of an elementary cell, block electrons, and block gas fuel passing at two ends.

Specifically, a polymer proton exchange membrane fuel cell (PEMFC) in the fuel cell uses a 5-layer membrane electrode assembly (MEAS). The MEAS includes a polymer electrolyte membrane arranged between two electrodes and an anode catalyst layer and a cathode catalyst layer located at two sides of the electrolyte membrane. The electrolyte membrane, for example, consists of PBI (polybenzimidazole), and a catalyst in the catalyst layer, for example, consists of alloy, nickel on carbon or palladium, or platinum metal catalyst and a mixture thereof. For mechanical support, current collection, or reactant distribution, the anode catalyst layer and the cathode catalyst layer are generally configured in adjacent to an anode gas diffusion layer and a cathode gas diffusion layer (for example, a porous conductive flaky material), and the catalyst layer and the gas diffusion layer are together referred to as a gas diffusion electrode (GDE).

In a manufacturing process of the fuel cell, the electrolyte membrane of the membrane electrode assembly needs to be immersed into an acidic or alkaline electrolyte solution first to form an electrode membrane containing liquid. In order to increase a power density of the fuel cell, a thickness of each layer structure of the elementary cell needs to be reduced, but the reduction of the thickness causes other limitations and problems. For example, easy cracking of a resin material of a sealing member of the membrane electrode assembly after long time use at high temperature, slippage or separation of the gas diffusion electrode and the electrolyte membrane from the sealing member, insufficient toughness or mechanical pressure resistance of the sealing member and the like all may cause gas or electrolyte seepage, or even cause problems of cell current leakage or fracture, etc., which leads to reduced cell performance and durability. That is, in order to ensure the effective operation of the cell, the sealing performance of the membrane electrode assembly, a flow field plate and the sealing member in the fuel cell is very important. Therefore, how to improve the sealing performance of the fuel cell is one of problems expected to be solved by those skilled in the art at present.

### SUMMARY OF THE INVENTION

The invention provides a flexible sealing structure which consists of a flexible sealing member and a membrane electrode assembly. The flexible sealing member can prevent gas or electrolyte liquid seepage, so that the formed flexible sealing structure has favorable cell performance and durability.

A flexible sealing structure according to the invention includes a flexible sealing member and a membrane electrode assembly. The flexible sealing member includes a first flexible sealing film and a second flexible sealing film. A hollow region is formed in a center of the flexible sealing member. The membrane electrode assembly is located between the first flexible sealing film and the second flexible sealing film. A side surface of the membrane electrode assembly is even. The membrane electrode assembly has a first surface and a second surface.

The hollow region of the flexible sealing member exposes a portion of the first surface and a portion of the second surface of the membrane electrode assembly.

In an embodiment of the invention, the hollow region of the flexible sealing member exposes 80% to 95% of the first surface and 80% to 95% of the second surface of the membrane electrode assembly.

In an embodiment of the invention, the two flexible sealing films are adhered to an edge of the first surface and an edge of the second surface of the membrane electrode assembly.

In an embodiment of the invention, the membrane electrode assembly sequentially includes a first electrode gas diffusion layer, a first electrode catalyst layer, an electrolyte membrane layer, a second electrode catalyst layer, and a second electrode gas diffusion layer in a direction from the first surface to the second surface.

In an embodiment of the invention, each of the first flexible sealing film and the second flexible sealing film includes a polymer layer and a thermosetting resin layer. The thermosetting resin layer of the first flexible sealing film is arranged near the first surface of the membrane electrode assembly, and the thermosetting resin layer of the second flexible sealing film is arranged near the second surface of the membrane electrode assembly.

In an embodiment of the invention, the thermosetting resin layers of the first flexible sealing film and the second flexible sealing film are opposite to be thermally bonded to each other.

In an embodiment of the invention, peripheries of the thermosetting resin layers of the first flexible sealing film and the second flexible sealing film are opposite to be thermally bonded to each other.

In an embodiment of the invention, a thickness of the thermosetting resin layer of each of the first flexible sealing film and the second flexible sealing film ranges between 25 μm and 300 μm.

In an embodiment of the invention, a thickness of the polymer layer of each of the first flexible sealing film and the second flexible sealing film ranges between 5 μm and 50 μm.

In an embodiment of the invention, a thickness of the membrane electrode assembly ranges between 200 μm and 1,000 μm.

Based on the above, in the flexible sealing structure (cell) of the invention, the membrane electrode assembly is a structure assembled in an even side surface mode, and is easy to process and align and suitable for mass production. After the stack-up membrane electrode assembly is sealed by the flexible sealing member, the gas or electrolyte liquid seepage can be effectively prevented, so that the formed flexible sealing structure has favorable cell performance and durability. Otherwise, in a structure assembled not in the even side surface mode, the problems of increase of required sealing film area range, aligning processing difficulty, gas and electrolyte liquid seepage, and the like are obvious.

To make the features and advantages of the invention clear and easy to understand, the following gives a detailed description of embodiments with reference to accompanying drawings.

### BRIEF DESCRIPTION OF THE DRAWINGS

FIG. 1A is a schematic top view illustrating a flexible sealing film according to an embodiment of the invention.

FIG. 1B is a schematic partial cross-sectional view taken along a line A-A′ in FIG. 1A.

FIG. 2 is a schematic partial cross-sectional view illustrating a flexible sealing structure according to an embodiment of the invention.

FIG. 3 is a schematic partial cross-sectional view illustrating a flexible sealing structure according to an embodiment of the invention.

FIG. 4 is a schematic partial cross-sectional view illustrating a flexible sealing structure after sealing according to an embodiment of the invention.

FIG. 5 is a schematic partial cross-sectional view illustrating a flexible sealing structure according to a comparative example of the invention.

FIG. 6 is a schematic partial cross-sectional view illustrating a flexible sealing structure after being assembled with a runner plate according to an embodiment of the invention.

FIG. 7 is an appearance photo of a flexible sealing structure according to the embodiments of the invention.

FIG. 8 is a partial appearance photo of FIG. 7.

FIG. 9 is a partial appearance photo of a finished product of a flexible sealing structure according to the embodiments of the invention.

### DESCRIPTION OF THE EMBODIMENTS

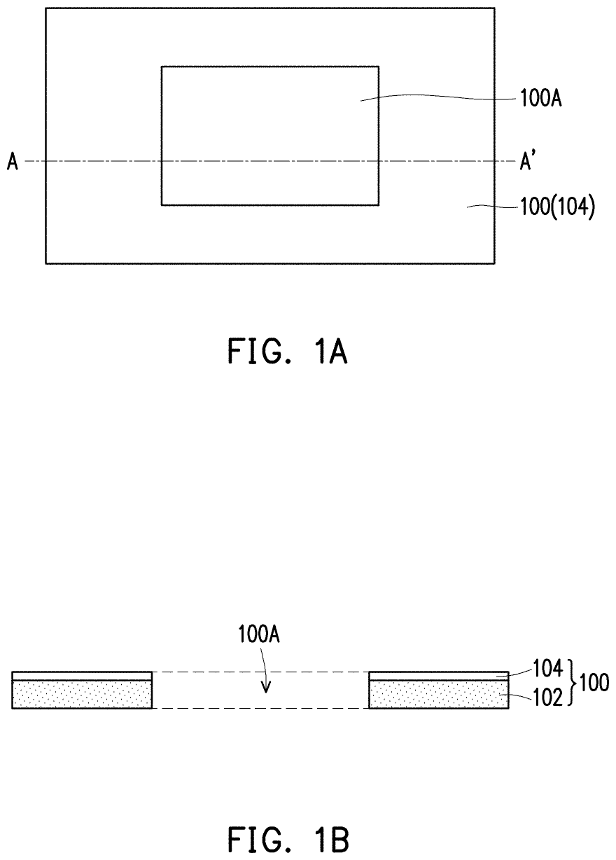

FIG. 1A is a schematic top view illustrating a flexible sealing film according to an embodiment of the invention. FIG. 1B is a schematic partial cross-sectional view taken along a line A-A′ in FIG. 1A.

Referring to FIG. 1A and FIG. 1B, this embodiment provides a flexible sealing film 100, including a polymer layer 104 and a thermosetting resin layer 102. The thermosetting resin layer 102 is arranged on a surface of the polymer layer 104.

In some embodiments, the polymer layer 104 consists of a heat-resistant polymer. In this embodiment, the heat-resistant polymer refers to a polymer having a glass transition temperature higher than 200° C. and a thermal decomposition temperature higher than 350° C., and preferably refers to a polymer having a glass transition temperature higher than 300° C. and a thermal decomposition temperature higher than 450° C. For example, a material of the polymer layer 104 is, for example, selected from a group consisting of polyimide, polyamide-imide, polybenzoxazole, polystyrene-butadiene copolymer, polyester, polyphenylsulfone, polysulfone, polyvinyl chloride, polypropylene, polytetrafluoroethylene, polyether-ether-ketone, polyphenylene sulfide and poly-cycloolefin polymers, and is preferably polyimide, but the invention is not limited thereto. In this embodiment, the polymer layer 104 is an airtight layer. In some embodiments, a thickness of the polymer layer is, for example, between 5 μm and 50 μm, preferably between 15 μm and 30 μm, but the invention is not limited thereto.

In this embodiment, thermosetting resin in the thermosetting resin layer 102 refers to a thermosetting polymer having a thermal cross-linking temperature higher than 90° C. and a thermal decomposition temperature higher than 250° C., and preferably refers to a thermosetting polymer having a thermal cross-linking temperature higher than 160° C. and a thermal decomposition temperature higher than 400° C. In some embodiments, the thermosetting resin layer 102, for example, consists of a non-halogen adhesive. For example, the non-halogen adhesive, for example, includes (a) 100 parts by weight of epoxy resin, (b) 50 parts by weight to 100 parts by weight of a phosphorous flame retardant, (c) 20 parts by weight to 50 parts by weight of a toughening agent, (d) 0.1 parts by weight to 2.0 parts by weight of a phosphine compound, (e) 2 parts by weight to 12 parts by weight of silicon dioxide and (f) 1 part by weight to 10 parts by weight of an ion exchanger.

In some embodiments, each molecule in the epoxy resin in the thermosetting resin layer 102, for example, includes two or more epoxy functional groups. For example, the epoxy resin is, for example, selected from a group consisting of phenolic resin, phenol A type epoxy resin, aromatic epoxy resin and aliphatic epoxy resin, but the invention is not limited thereto.

In some embodiments, the phosphorous flame retardant in the thermosetting resin layer 102 may be configured to provide flame-retardant characteristics of the non-halogen adhesive. In some embodiments, the phosphorous flame retardant is, for example, selected from a group consisting of aliphatic phosphate, aromatic phosphate and aromatic condensed phosphate shown as Formula 1.

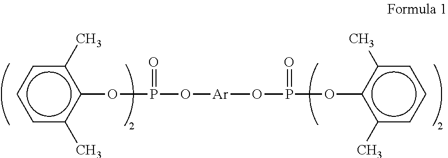

Ar is aryl. For example, the aliphatic phosphate, for example, includes tributyl phosphate and triethyl phosphate (TEP). The aromatic phosphate, for example, includes triphenyl phosphate (TPP), dimethyl methyl phosphate (DMMP), triphenyl phosphite and tricresyl phosphate, but the invention is not limited thereto. It is worth mentioning that if the addition amount of the phosphorous flame retardant is lower than 50 parts by weight relative to 100 parts by weight of the epoxy resin, the flame retardant performance of the prepared non-halogen adhesive is poor; otherwise, if the addition amount of the phosphorous flame retardant is higher than 100 parts by weight relative to 100 parts by weight of the epoxy resin, the heat resistant performance of the prepared non-halogen adhesive is reduced, and the peeling strength of the non-halogen adhesive cannot conform to the standard specification.

In some embodiments, the toughening agent in the thermosetting resin layer 102 may be configured to provide high flexibility required by the non-halogen adhesive after high-temperature curing, i.e., the toughening agent may be configured to increase the toughness of the non-halogen adhesive. In some embodiments, the toughening agent, for example, may include rubber or a diepoxide. Specifically, the toughening agent is, for example, selected from a group consisting of rubber including carboxyl and cyano groups, rubber including sec-amino and cyano groups, rubber including epoxy and cyano groups, and a diepoxide, but the invention is not limited thereto. For example, the rubber including carboxyl and cyano groups is, for example, carboxy-terminated butadiene-acrylonitrile (CTBN), which has a structure formula shown as Formula 2 below.

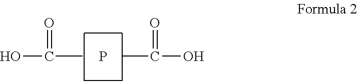

[symbol]

represents a structure formula shown as Formula 3 below ( [symbol] represents the same structure hereafter).

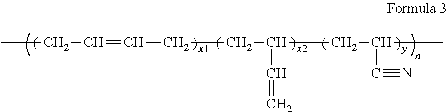

X₁, X₂, y, and n are integers of 1 or greater. The rubber including sec-amino and cyano groups is, for exmple, amine-terminated butadiene-acrylonitrile (ATBN), which has a structure formula shown as Formula 4 below.

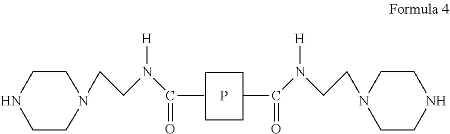

The rubber including epoxy and cyano groups is, for example, epoxide-terminated butadiene-acrylonitrile (ETBN), which has a structure formula shown as Formula 5 below.

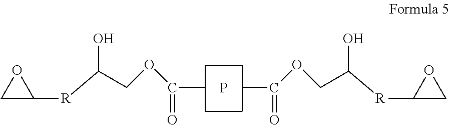

The diepoxide, for example, has a structure formula shown as Formula 6 below.

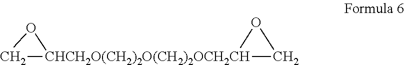

The diepoxide may also be butanediol diglycidoylether, which has a structure formula shown as Formula 7 as follows:

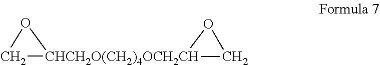

The diepoxide may also be diglycidyl resorcinol ether, which has a structure formula shown as Formula 8 below.

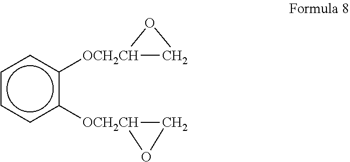

In this embodiment, the toughening agent may, for example, include one or a combination of the rubber or diepoxide.

In some embodiments, the phosphine compound in the thermosetting resin layer 102 may be used as a main catalyst for the non-halogen adhesive. In some embodiments, the phosphine compound, for example, includes triphenyl phosphine (TPP), ethyl triphenyl phosphine bromide (ETPPB), ethyl triphenyl phosphine iodide (ETPPI) or combinations thereof. The TPP has a structure formula shown as Formula 9 below.

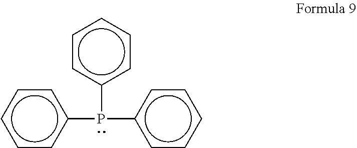

The TPP compound can effectively promot a polymerization reaction between the epoxy resin having a reactive functional group at the end of a molecular chain and the toughening agent.

In some embodiments, the silicon dioxide in the thermosetting resin layer 102 may be subjected to surface hydrophobic treatment. In a specific embodiment, the silicon dioxide is, for example, subjected to surface hydrophobic treatment with hexamethyldisilazane, the silicon dioxide after being subjected to surface hydrophobic treatment has lipophilicity, but the invention is not limited thereto. In some embodiments, a particle diameter of the silicon dioxide is, for example, between 20 nm and 300 nm. It is worth mentioning that if the silicon dioxide is not subjected to surface hydrophobic treatment, or the addition amount of the silicon dioxide subjected to the surface hydrophobic treatment is lower than 2 parts by weight relative to 100 parts by weight of the epoxy resin, the flame retardant performance of the prepared non-halogen adhesive is poor; otherwise, if the addition amount of the silicon dioxide subjected to surface hydrophobic treatment is higher than 12 parts by weight relative to 100 parts by weight of the epoxy resin, the peeling strength of the non-halogen adhesive cannot reach the standard specification.

In some embodiments, the ion exchanger in the thermosetting resin layer 102, for example, includes a cation exchanger or an anion exchanger. For example, the cation exchanger, for example, includes Sb₂O₅.2H₂O the anion exchanger, for example, includes Bi(OH)_{0.7}(NO₃)_{0.3}, BiO(OH)_{0.74}(NO₃)_{0.15}(HsiO₂)_{0.11}, BiO(OH) or combinations thereof, but the invention is not limited thereto.

In some embodiments, a solvent used by the non-halogen adhesive in the thermosetting resin layer 102 is, for example, selected from a group consisting of methyl ethyl ketone, acetone, methyl alcohol, ethyl alcohol, isopropanol, n-propyl alcohol, methylbenzene and xylene, but the invention is not limited thereto. It is worth noting that the solvent used has a wetting effect on the silicon dioxide subjected to surface hydrophobic treatment.

The epoxy resin, the phosphorous flame retardant, the toughening agent, the phosphine compound, the silicon dioxide and the ion exchanger are used as a main agent of the non-halogen adhesive. In this embodiment, a preparation mode of the non-halogen adhesive is, for example, that the main agent is prepared first, i.e., the epoxy resin, the phosphorous flame retardant, the toughening agent, the phosphine compound, the silicon dioxide and the ion exchanger in the main agent are completely dissolved into the solvent first, and the main agent is formed after the reaction completion. Next, a hardening agent and a hardening catalyst at a specific proportion are added into the main agent, and are uniformly mixed to prepare the non-halogen adhesive. In detail, after the non-halogen adhesive is coated onto a base plate (for example, a polymer layer 104) to be formed by a coating machine, during oven drying and high-temperature curing, the hardening agent can generate a cross-linking effect with the epoxy resin in the main agent, and the hardening catalyst can be configured to improve a cross-linking rate of the hardening agent and the epoxy resin in the non-halogen adhesive. The polymer layer 104 after being subjected to high-temperature curing and the thermosetting resin layer 102 form the flexible sealing film 100 in the present embodiment. A hollow region 110A is cut in the center of the flexible sealing film 100 in a subsequent procedure according to requirements (described in detail later). In some embodiments, a drying temperature is, for example, between 100° C. and 150° C., and a drying time is, for example, between 1 minute and 3 minutes, but the invention is not limited thereto.

In some embodiments, the hardening agent is, for example, selected from a group consisting of cyanoguanidine, diethylene triamine, diethylene tetraamine, diamino diphenyl methane, diamino diphenyl sulfone, phthalic anhydride, tetrahydro phthalic anhydride, boron trifluoride amine complex compounds, multi-functional epoxy and phenolic resin, and one or a combination of the above may be selected to be used according to requirements, but the invention is not limited thereto. In some embodiments, the consumption of the hardening agent is, for example, 1 part by weight to 20 parts by weight relative to 100 parts by weight of the main agent, but the invention is not limited thereto.

In some embodiments, the hardening catalyst is, for example, selected from a group consisting of 2-phenylimidazole, 1-phenyl-2-methyl imidazole, 2-ethyl-4-methyl imidazole, BF3 monoethylamine, zinc borofluoride, tin borofluoride, zickel borofluoride and piperidine (PIP), and one or a combination of the above may be selected to be used according to requirements, but the invention is not limited thereto. In some embodiments, the consumption of the hardening catalyst is, for example, 0.1 parts by weight to 2 parts by weight relative to 100 parts by weight of the main agent, but the invention is not limited thereto.

In some embodiments, the thickness of the thermosetting resin layer 102 is, for example, between 25 μm and 300 μm, and is preferably between 50 μm and 200 μm, but the invention is not limited thereto. In some embodiments, the thermal cross-linking temperature of the thermosetting resin layer 102 is, for example, higher than 90° C., and the thermal decomposition temperature is, for example, higher than 250° C., but the invention is not limited thereto.

Referring to FIG. 1A and FIG. 1B, in the present embodiment, a manufacturing mode of the flexible sealing film 100, for example, is that the non-halogen adhesive is coated onto one surface of the polymer layer 104 first, a drying manufacturing process is then performed at an temperature, for example, between 100° C. and 140° C. so as to form the thermosetting resin layer 102 on the surface of the polymer layer 104. Next, the hollow region 100A is cut in the center of the flexible sealing film 100 of a double-layer structure. In a subsequent manufacturing process, when the flexible sealing film 100 prepared according to the present embodiment is applied to sealing of the fuel cell, the hollow region 100A can be used for passage of fuel gas of the fuel cell.

It is worth mentioning that the non-halogen adhesive of the present embodiment includes the silicon dioxide, the toughening agent and the ion exchanger, so that the thermosetting resin layer 102 formed with the above-mentioned non-halogen adhesive can reduce the air permeability of the thermosetting resin layer 102 to effectively prevent the gas leakage, thereby improving the high-temperature resistance, toughness, flexibility and electric insulation performance. Further, when the flexible sealing film 100 is applied to fuel cell packaging, in case that a seal package of the fuel cell is compressed and the fuel cell runs for a long time, the flexible sealing film 100 of the present embodiment has high flatness and airtightness, so that the electrolyte liquid seepage of the membrane electrode assembly (described in detail later) in the fuel cell can be prevented. That is, the flexible sealing film of the invention is applicable to the packaging of flexible fuel cells, is preferably applicable to a phosphoric acid fuel cell and an alkaline fuel cell, and is more preferably applicable to the phosphoric acid fuel cell, but the invention is not limited thereto.

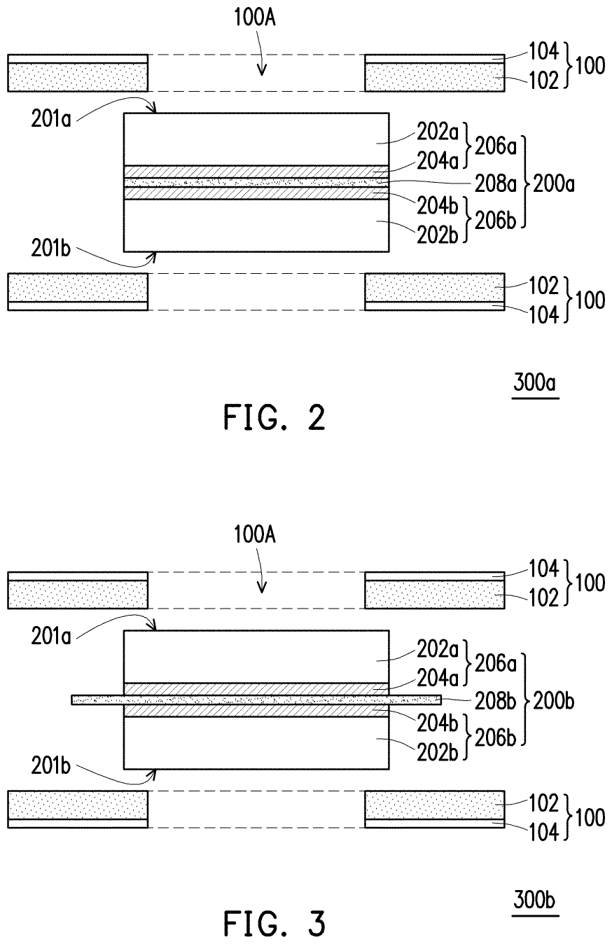

FIG. 2 is a schematic partial cross-sectional view illustrating a flexible sealing structure according to an embodiment of the invention.

Referring to FIG. 2, in this embodiment, the two flexible sealing films 100 form a flexible sealing member, and the thermosetting resin layers 102 of the flexible sealing films 100 are opposite to be thermally bonded to each other. In the present embodiment, a flexible sealing structure 300a includes the flexible sealing member consisting of two flexible sealing films 100 and a membrane electrode assembly 200a, and the membrane electrode assembly 200a is located between the two flexible sealing films 100.

In detail, the membrane electrode assembly 200a has a first surface 201a and a second surface 201b, the hollow region 100A in the center of the two flexible sealing films 100 exposes a portion of the first surface 201a and a portion of the second surface 201b of the membrane electrode assembly 200a. In some embodiments, the hollow region 100A exposes 80% to 95% of the first surface 201a and 80% to 95% of the second surface 201b of the membrane electrode assembly 200a, but the invention is not limited thereto.

In some embodiments, the membrane electrode assembly 200a sequentially includes a first electrode gas diffusion layer 202a, a first electrode catalyst layer 204a, an electrolyte membrane layer 208a, a second electrode catalyst layer 204b, and a second electrode gas diffusion layer 202b in a direction from the first surface 201a to the second surface 201b.

In some embodiments, a phosphoric acid solution needs to be contained in the electrolyte membrane layer 208a of the membrane electrode assembly 200a to be used as a hydrogen proton conduction material. In a specific embodiment, a manufacturing mode of the electrolyte membrane layer 208a using the phosphoric acid solution as acidic electrolyte liquid is, for example, immersing an electrolyte membrane into the phosphoric acid electrolyte liquid. For example, a polybenzimidazole (PBI) electrolyte membrane may be elected to be immersed into the phosphoric acid solution to obtain the electrolyte membrane layer 208a containing the phosphoric acid electrolyte liquid, where an immersing temperature is, for example, between 60° C. and 140° C., an immersing time is, for example, between 1 hour and 14 hours, a total phosphoric acid immersion quantity is about 180 wt % to 300 wt %. In other embodiments, a potassium hydroxide solution, for example, may be contained in the electrolyte membrane layer 208a of the membrane electrode assembly 200a to be used as a hydroxyl ion conduction material. In a specific embodiment, a manufacturing mode of the electrolyte membrane layer 208a using the potassium hydroxide solution as alkaline electrolyte liquid is, for example, immersing an electrolyte membrane into the potassium hydroxide electrolyte liquid. For example, a PBI electrolyte membrane may be selected to be immersed into the potassium hydroxide solution to obtain the electrolyte membrane layer 208a containing the potassium hydroxide electrolyte liquid, where an immersing temperature is, for example, between 60° C. and 140° C., an immersing time is, for example, between 1 hour and 14 hours, a total potassium hydroxide immersion quantity is about 180 wt % to 300 wt %.

In some embodiments, the first electrode gas diffusion layer 202a and the first electrode catalyst layer 204a constitute a first gas diffusion electrode 206a, and the second electrode gas diffusion layer 202b and the second electrode catalyst layer 204b constitute a second gas diffusion electrode 206b. In a specific embodiment, a manufacturing mode of the first gas diffusion electrode 206a/the second gas diffusion electrode 206b is, for example, using carbon cloth or carbon paper as the first electrode gas diffusion layer 202a/the second electrode gas diffusion layer 202b, next, mixing commercial Pt/C and DMAc solvents according to a proportion of 1:10 to prepare a Pt/C catalyst slurry, coating the Pt/C catalyst slurry onto the first electrode gas diffusion layer 202a/the second electrode gas diffusion layer 202b in a scraping coating or spray coating mode, and performing drying at a temperature of 140° C. to 200° C. so as to form the first electrode catalyst layer 204a/the second electrode catalyst layer 204b on the first electrode gas diffusion layer 202a/the second electrode gas diffusion layer 202b. The total Pt content is, for example, between about 0.15 mg/cm² and 1 mg/cm², but the invention is not limited thereto. So far, the first gas diffusion electrode 206a and the second gas diffusion electrode 206b can be respectively prepared.

Next, the first electrode catalyst layer 204a of the first gas diffusion electrode 206a and the second electrode catalyst layer 204b of the second gas diffusion electrode 206b are opposite to each other to be stacked up with the electrolyte membrane layer 208a containing the electrolyte liquid being placed therebetween. That is, the first electrode gas diffusion layer 202a, the first electrode catalyst layer 204a, the electrolyte membrane layer 208a, the second electrode catalyst layer 204b and the second electrode gas diffusion layer 202b are sequentially arranged sequentially from top to bottom (as shown in FIG. 2). Then, thermal pressing bonding is performed so as to form a five-layer stacked membrane electrode assembly 200a. In some embodiments, a thermal pressing bonding temperature is, for example, between 100° C. and 200° C., a thermal pressing bonding pressure is, for example, between 10 MPa and 40 MPa, but the invention is not limited thereto. Finally, the thermal pressing bonded membrane electrode assembly 200a is cut into a desired dimension, such as the dimension with an area being 5.4×5.4 cm² or 11.4×15.4 cm². In some embodiments, a thickness of the membrane electrode assembly 200a is, for example, between 200 μm and 1000 μm, but the invention is not limited thereto.

As shown in FIG. 2, in this embodiment, the membrane electrode assembly 200a uses an even side surface assembly mode. That is, the first gas diffusion electrode 206a, the electrolyte membrane layer 208a and the second gas diffusion electrode 206b have a same dimension, and the electrolyte membrane layer 208a is not projected out of the first gas diffusion electrode 206a or the second gas diffusion electrode 206b. That is, a side surface of the membrane electrode assembly 200a is a flat plane.

In this embodiment, the first gas diffusion electrode 206a, the first electrode gas diffusion layer 202a and the first electrode catalyst layer 204a may respectively represent a gas diffusion anode, an anode gas diffusion layer and an anode catalyst layer, while the second gas diffusion electrode 206b, the second electrode gas diffusion layer 202b and the second electrode catalyst layer 204b respectively represent a gas diffusion cathode, a cathode gas diffusion layer and a cathode catalyst layer, and vice versa.

FIG. 3 is a schematic partial cross-sectional view illustrating a flexible sealing structure according to an embodiment of the invention.

Referring to FIG. 3, in this embodiment, a membrane electrode assembly 200b uses an uneven side surface assembly mode. That is, an electrolyte membrane layer 208b of the membrane electrode assembly 200b is projected out of side edges of the first gas diffusion electrode 206a and the second gas diffusion electrode 206b. In other words, a side surface of the membrane electrode assembly 200b is not a flat plane. For example, in the present embodiment, the first gas diffusion electrode 206a and the second gas diffusion electrode 206b may be cut into a dimension with an area, for example, being 5.4×5.4 cm² or 11.4×15.4 cm². Next, the electrolyte membrane layer 208b with an area, for example, being 6×6 cm² or 12×15 cm² is placed between the first gas diffusion electrode 206a and the second gas diffusion electrode 206b. Then, thermal pressing bonding is performed as described in the above embodiment so as to form the membrane electrode assembly 200b as shown in FIG. 3.

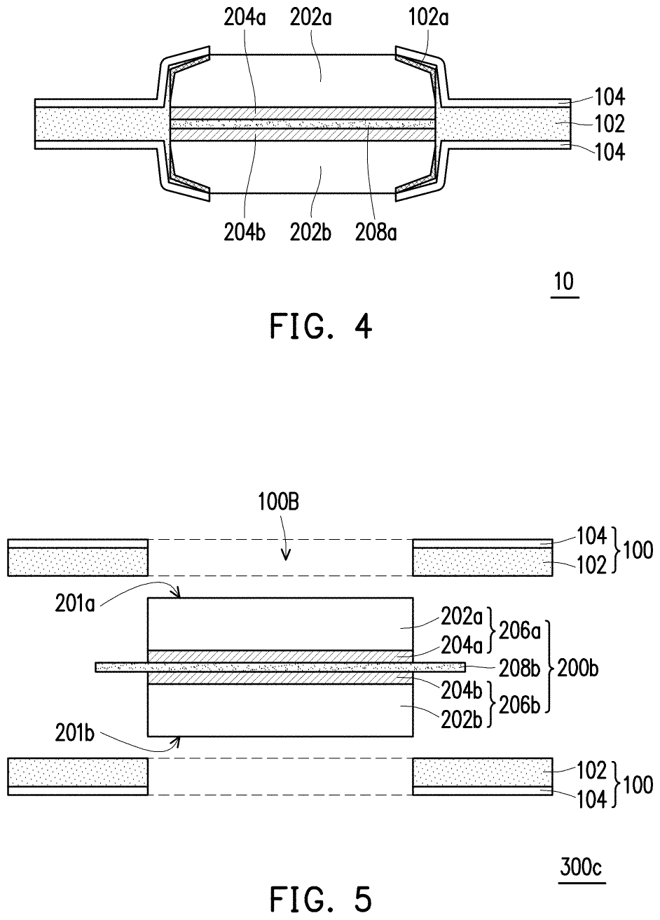

FIG. 4 is a schematic partial cross-sectional view illustrating a flexible sealing structure after sealing according to an embodiment of the invention.

Referring to FIG. 2 and FIG. 4, the two flexible sealing films 100 are used to perform a sealing manufacturing process of the membrane electrode assembly 200a. In this embodiment, the assembly mode of the membrane electrode assembly 200a with the side surface being even is illustrated (as shown in FIG. 2), but the invention is not limited thereto. That is, in other embodiments of the invention, the membrane electrode assembly 200b may also be subjected to a sealing manufacturing process in the uneven side surface assembly mode (shown as FIG. 3). In this embodiment, the hollow region 100A is formed in the center of the two flexible sealing films 100. In some embodiments, an area of the hollow region 100A is approximately equal to a surface area of the first gas diffusion electrode 206a or the second gas diffusion electrode 206b (a length and a width are deducted by 2 cm to 4 cm respectively). That is, the area of the hollow region 100A is, for example, 5×5 cm² or 11×15 cm², but the invention is not limited thereto. Then, the membrane electrode assembly 200a is arranged between the two flexible sealing films 100, and the thermosetting resin layers 102 of the two flexible sealing films 100 are opposite to each other, and thermal pressing sealing is performed by a vacuum heater press to obtain the flexible sealing structure 10 after sealing as shown in FIG. 4, where a vacuum degree of the thermal pressing is, for example, greater than 75 KPa, a temperature is, for example, between 100° C. and 200° C., a pressure is, for example, between 10 MPa and 40 MPa. In this embodiment, the flexible sealing films 100 are adhered onto surface edges of the first electrode gas diffusion layer 202a and the second electrode gas diffusion layer 202b. The thermosetting resin 102a of part of the thermosetting resin layer 102 can seep into the first electrode gas diffusion layer 202a and the second electrode gas diffusion layer 202b, and peripheries of the thermosetting resin layer 102 of the two flexible sealing films 100 are opposite to be thermally bonded to each other. In this embodiment, the side surface of the membrane electrode assembly 200a is even, so that the side edge of the membrane electrode assembly 200a may be bonded first, and then thermally pressed to be bonded, so that the problem of liquid electrolyte seepage can be prevented, but the invention is not limited thereto.

It is worth mentioning that the flexible sealing structure 10 after sealing can provide mechanical intensity and flexibility during flexure or compression of the membrane electrode assembly 200a to solve the problem of electrolyte liquid overflowing and leakage during packaging, and also can separate an anode and a cathode from fuel gas in an ambient environment to prevent mutual passing of fuel at two ends of the membrane electrode assembly 200a, thereby improving the electric power density and stability of the cell.

### Experiments

The invention will be specifically illustrated with reference to exemplary embodiments hereafter. Although the following experiments are illustrated, the used materials, content and rate, processing details, processing flow process, etc. can be properly changed without departing from the scope of the invention. Therefore, the invention should not be restrictively interpreted according to experiments described below.

### Experiment 1

Hereafter, the characteristics of the thermosetting resin layer in the flexible sealing film of the invention are illustrated in detail with reference to Table 1 and Table 2.

The thermosetting resin layers in Example 1 to Example 4 and Comparative Examples will be prepared according to the main agent composition and proportion in Table 1 below:

TABLE 1

| | | Example number | | | | |
|---|---|---|---|---|---|---|
| | | | | | | Comparative |
| Composition (parts by weight) | | Example 1 | Example 2 | Example 3 | Example 4 | Example |
| Epoxy resin (Note 1) | | 100 | 100 | 100 | 100 | 100 |
| Phosphorous flame retardant (Note 2) | | 50 | 100 | 75 | 75 | 0 |
| Silicon dioxide (Note 3) | | 5 | 5 | 2 | 8 | 0 |
| Toughing agent | Liquid-state NBR (Note 4) | 24 | 0 | 24 | 0 | 0 |
| | Solid-state NBR (Note 5) | 12 | 0 | 12 | 0 | 0 |
| | NBR derivative (Note 6) | 0 | 36 | 0 | 0 | 36 |
| Phosphine compound | TPP (Note 7) | 0.2 | 0.2 | 0.2 | 0.2 | 0.2 |
| Ion exchanger | Sb₂O₃•2H₂O | 1.5 | 1.5 | 1.5 | 0 | 1.5 |
| | Bi(OH)_{0.7}(NO3)_{0.3} | 1.5 | 1.5 | 1.5 | 0 | 1.5 |
| Solvent | Methyl ethyl ketone | 187 | 237 | 204 | 100 | 215 |
| | N-propyl alcohol | 8 | 8 | 8 | 8 | 8 |
| Finished product | Viscosity (cps) | 300 | 300 | 300 | 300 | 300 |
| | Solid content (%) | 50 | 50 | 50 | 50 | 50 |
| | pH value | 6.8 | 7.7 | 6.5 | 6.6 | 7.3 |

(Note 1):
manufactured by Changchun Chemical, trade name: EB 501
(Note 2):
manufactured by Daihachi Chemical Industry, trade name: PX-200 aromatic condensed phosphate
(Note 3):
particle diameter: smaller than 100 nm, subjected to surface hydrophobic treatment by hexamethyldisilazane, having lipophilicity
(Note 4):
liquid-state acrylonitrile-butadiene rubber, manufactured by Goodrich Co., trade name: CTBN1300*8
(Note 5):
liquid-state acrylonitrile-butadiene rubber, manufactured by Nantex Chemical, trade name: Hycarl042
(Note 6):
liquid-state acrylonitrile-butadiene rubber, manufactured by Goodrich Co., trade name: ATBN1300*35
(Note 7):
triphenyl phosphine

In each Example above, a reaction temperature is 85° C., a reaction pressure is 1 atm, and the steps of the main agent of each Example is as follows:

Step 1: the solvent, the phosphorous flame retardant, and the silicon dioxide are mixed and stirred for 1 hour to form a mixture 1.

Step 2: the toughening agent is added into the mixture 1 and is stirred for 2 hours to form a mixture 2.

Step 3: the epoxy resin is added into the mixture 2 and is stirred for 2 hours to form a mixture 3.

Step 4: the phosphorous compound and the ion exchanger are added into the mixture 3 for reaction for 24 hours to prepare the required main agent of the invention for later use.

In Addition, a preparation mode of the hardening agent in each Example is dissolving 12 kg of diamino diphenyl sulfone into 18 kg of acetone to prepare a total of 30 kg of hardening agent for later use. A preparation mode of the hardening catalyst in each Example is dissolving 0.5 kg of boron trifluoride into 1.5 kg of monoethylamine to prepare a total of 2.0 kg of hardening catalyst for later use.

Next, 100 parts by weight of the main agent, 30 parts by weight of the hardening agent (including about 12 parts by weight of the diamino diphenyl sulfone) and 2 parts by weight of the hardening catalyst (including about 0.5 parts by weight of BF3 monoethylamine) are mixed to prepare the non-halogen adhesive with a viscosity of 200 cps.

The above-mentioned non-halogen adhesive is coated onto a plastic release sheet having thickness of 12 μm, where a coating thickness is 50 μm, and then, drying is performed for 3 minutes at a temperature of 150° C., so as to prepare the thermosetting resin layer. Next, the two thermosetting resin layers are face to face to be thermally pressed and bonded, where the thermal pressing bonding temperature is 120° C., the thermal pressing bonding pressure is 10 kg, the plastic release sheets at two sides are peeled off to prepare the stacked thermosetting resin layer having a thickness of 50 μm. Finally, the stacked thermosetting resin layer is subjected to high-temperature curing for 12 hours at 170° C. to obtain the thermosetting resin layer of each Example.

Next, the flame-retardant performance, peeling strength, electric property, flexibility, and solvent resistance test is performed for a test piece (the thermosetting resin layer) of each Example above. Test manners are provided as follows.

(1) A flame-retardant performance test: a VTM-O test is performed according to UL94 authentication.
(2) A peeling strength test: a test is performed according to IPC TM650 2, 4, 9 methods, the test piece is cut with a width of about 1 cm, and the peeling strength of the test piece is tested by a tension machine.
(3) Surface impedance: a test is performed according to IPC TM650 2, 5, 17 methods.
(4) Volume impedance: a test is performed according to IPC TM650 2, 5, 17 methods.
(5) A flexibility test: a test is performed according to an MIT method and IPC TM650 2, 4, 3 methods.
(6) An environment resistance test: the test piece is placed in a constant-temperature and constant-humidity machine at 80° C. and 100% RH for 1,000 hours, and then the peeling strength of the test piece is tested.
(7) A gas permeability test: in the test, the gas permeability is tested by a pressure difference method test principle. The pre-treated test piece is placed and clamped between upper and lower test cavities. Firstly, vacuum treatment is carried out on a low-pressure cavity (the lower cavity); then, the whole system is vacuumized; the test lower cavity is closed after a specified vacuum degree is reached; test gas at a certain pressure is charged into a high-pressure cavity (the upper cavity); and a constant pressure difference is enabled to be formed at two sides of the test piece, so that the gas seeps from a high-pressure side to a low-pressure side under the effect of the pressure difference gradient, and each blocking performance parameter of the tested test piece is obtained through monitoring the pressure intensity at the low-pressure side.
(8) Solvent resistance: the test pieces are respectively placed into 10.26 M phosphoric acid, 1 M sodium hydroxide and 1 M potassium hydroxide boiling solvents for 2 h, and then cleaned with deionized water, and then the gas permeability detection is performed.

TABLE 2

| | | Experiment number | | | | |
|---|---|---|---|---|---|---|
| | | | | | | Comparative |
| Composition (parts by weight) | | Example 1 | Example 2 | Example 3 | Example 4 | Example |
| Flame-retardant performance (Note 8) | | ◯ | ◯ | ◯ | ◯ | X |
| Peeling strength (kgf) | | >1.2 | >1.2 | >1.2 | >1.2 | >1.2 |
| Electric | Surface impedance (Ω, 0.1 mm) | >10¹³ | >10¹³ | >10¹³ | >10¹³ | >10¹³ |
| characteristics | Volume impedance (Ω, 0.1) mm) | >10¹⁴ | >10¹⁴ | >10¹⁴ | >10¹⁴ | >10¹⁴ |
| Flexibility | Bending radius 2 mm | >1 × 10⁶ | >1 × 10⁶ | >1 × 10⁶ | >3 × 10³ | >1 × 10⁶ |
| | Bending radius 1 mm | >1 × 10⁶ | >1 × 10⁶ | >1 × 10⁶ | >3 × 10³ | >1 × 10⁶ |
| High-humidity | Peeling strength(kgf) | >1.0 | >1.0 | >1.0 | >1.0 | >1.0 |
| resistance | | | | | | |
| Gas permeability (cm³/m² · | | >130 | >130 | >150 | >100 | >300 |
| 24 h · 1 atm, 25° C.) | | | | | | |
| Solvent | Boiling phosphoric acid | >200 | >200 | >250 | >350 | >450 |
| resistance | (10.26M) gas permeability | | | | | |
| | after 2 hours (cm³/m² · | | | | | |
| | 24 h · 1 atm, 25° C.) | | | | | |
| | Boiling sodium hydroxide | >200 | >200 | >250 | >350 | >450 |
| | (1M) gas permeability | | | | | |
| | after 2 h (cm³/m² · | | | | | |
| | 24 h · 1 atm, 25° C.) | | | | | |
| | Boiling potassium hydroxide | >200 | >200 | >250 | >350 | >450 |
| | (1M) gas permeability | | | | | |
| | after 2 h (cm³/m² · | | | | | |
| | 24 h · 1 atm, 25° C.) | | | | | |

(Note 8):
the symbol “◯” in the flame-retardant performance test indicates that the VTM-0 test of UL authentication is passed, and the symbol “X” indicates that the test cannot be passed.

From above results, the thermosetting resin layers of Example 1 to Example 4 in the experiment have higher flame-retardant performance, electric property, flexibility, and solvent resistance than the thermosetting resin layer in Comparative Example.

### Experiment 2

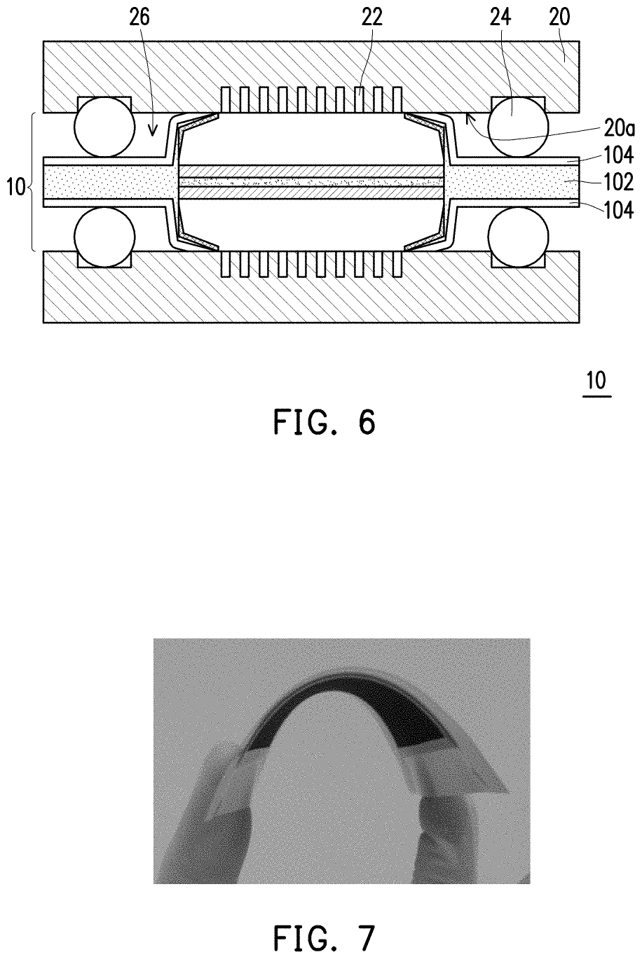

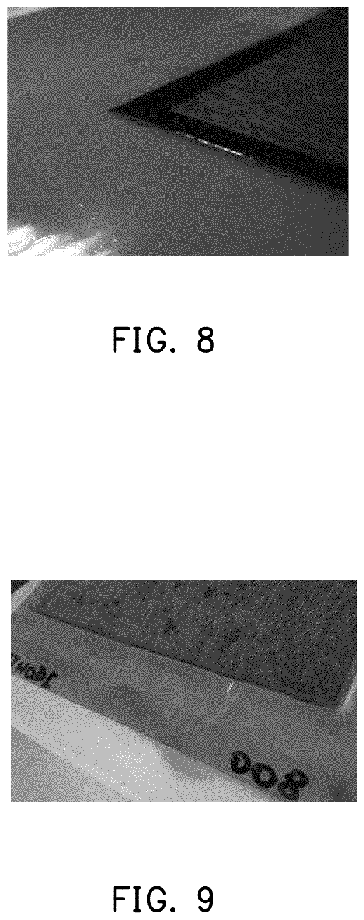

FIG. 5 is a schematic partial cross-sectional view illustrating a flexible sealing structure according to a comparative example of the invention. FIG. 6 is a schematic partial cross-sectional view illustrating a flexible sealing structure after being assembled with a runner plate according to an embodiment of the invention. FIG. 7 is an appearance photo of a flexible sealing structure according to the embodiments of the invention. FIG. 8 is a partial appearance photo of FIG. 7. FIG. 9 is a partial appearance photo of a finished product of a flexible sealing structure according to the embodiments of the invention.

Hereafter, characteristics of the flexible sealing structure of the invention are illustrated in detail with reference to Table 3 and FIG. 2 to FIG. 9.

### Example 1

In the present embodiment, a membrane electrode assembly uses an even side surface assembly mode (as shown in FIG. 2). An electrolyte membrane layer in the membrane electrode assembly is a polybenzimidazole (PBI) electrolyte membrane. A preparation mode is immersing the PBI electrolyte membrane into phosphoric acid for 1 hour at 60° C. to enable the total immersion amount to be approximately between 180 wt % and 220 wt % to obtain a phosphorylated PBI electrolyte membrane. A gas diffusion electrode in the membrane electrode assembly uses carbon cloth as a cathode gas diffusion layer and an anode gas diffusion layer, which has a thickness of 370 μm. Next, for an electrode catalyst layer in the gas diffusion electrode, a commercial Pt/C catalyst slurry is coated onto the cathode gas diffusion layer and the anode gas diffusion layer, and is dried at 160° C. to form an electrode catalyst layer on each of the cathode gas diffusion layer and the anode gas diffusion layer, the cathode gas diffusion layer having the electrode catalyst layer is a cathode gas diffusion electrode herein, the anode gas diffusion layer having the cathode catalyst layer is an anode gas diffusion electrode herein, and the total Pt content is about 1 mg/cm². Next, the electrode catalyst layer of the cathode gas diffusion electrode and the electrode catalyst layer of the anode gas diffusion electrode are respectively placed on two side surfaces of the phosphorylated PBI electrolyte membrane, then, a hot pressing manufacturing process is performed to form the membrane electrode assembly of the present embodiment, where a temperature of the hot pressing manufacturing process is, for example, between 130° C. and 160° C., and a pressure is, for example, between 20 Mpa and 30 MPa. Finally, the prepared membrane electrode assembly is cut into a square dimension having an area of 5×5 cm².

In the present embodiment, the flexible sealing member consists of two flexible sealing films. A preparation mode of the flexible sealing film is coating a non-halogen adhesive in Example 3 above onto a polyimide plastic film having a thickness of 25 μm, where a coating thickness is 50 μm, and then performing drying for 3 minutes at a temperature of 150° C. to obtain the flexible sealing film of the present embodiment.

Next, a sealing manufacturing process of the membrane electrode assembly is performed. In the present embodiment, a total area of the flexible sealing film is 9×9 cm². A hollow region is formed in the center of the flexible sealing film, has an area of 4.8×4.8 cm², and can allow the passage of fuel gas of the membrane electrode assembly. The sealing manufacturing process includes the steps of placing the membrane electrode assembly between the two flexible sealing films, where thermosetting resin layers of the flexible sealing films respectively face the membrane electrode assembly; and next, performing thermal pressing sealing bonding by a vacuum heater press, where a vacuum degree of the hot pressing sealing is 75 KPa, a temperature of the hot pressing sealing is, for example, between 140° C. and 160° C., and a pressure is, for example, between 20 MPa and 30 MPa. So far, the flexible sealing structure (cell) of the present embodiment can be obtained.

### Example 2

The flexible sealing structure according to Example 2 is prepared according to a preparation procedure similar to that of Example 1. The difference is that in Example 2, a preparation mode of the flexible sealing film uses a non-halogen adhesive of Comparative Example above. Other manufacturing processes are all performed with reference to Example 1 to obtain the flexible sealing structure (cell) of the present embodiment.

### Comparative Example 1

The flexible sealing structure of Comparative Example 1 is prepared according to a preparation procedure similar to that of Example 1. The difference is that in Comparative Example 1, a membrane electrode assembly uses an uneven side surface assembly mode. That is, an electrolyte membrane layer in the membrane electrode assembly is projected out of the cathode gas diffusion electrode and the anode gas diffusion electrode (as shown in FIG. 3). In detail, in the present embodiment, the cathode gas diffusion electrode and the anode gas diffusion electrode are, for example, cut into a square dimension with an area of 5×5 cm², a phosphorylated PBI electrolyte membrane is cut into a square dimension with an area being greater than that of the gas diffusion electrode, for example, a square dimension with an area of 6.5×6.5 cm². Therefore, the phosphorylated PBI electrolyte membrane in the present embodiment is exposed to peripheries of the cathode gas diffusion electrode and the anode gas diffusion electrode. In a subsequent sealing manufacturing process of the membrane electrode assembly, the flexible sealing member may be adhered onto a part of the phosphorylated PBI electrolyte membrane projected from the gas diffusion electrodes, and peripheral surfaces of the gas diffusion electrodes. Next, a sealing manufacturing process the same as that of Example 1 is performed to obtain the flexible sealing structure (cell) of the comparative example.

### Comparative Example 2

The flexible sealing structure of Comparative Example 2 is prepared according to a preparation procedure similar to that of Comparative Example 1. The difference is that in Comparative Example 2, an area of a hollow region 100B of the flexible sealing film 100 is greater than or equal to an area of a cathode gas diffusion electrode and a anode gas diffusion region, and is, for example, 5.1×5.1 cm², but needs to be smaller than an area of the phosphorylated PBI electrolyte membrane. That is, in Comparative Example 2, the flexible sealing film is adhered only to the part of the phosphorylated PBI electrolyte membrane projected from the gas diffusion electrode, and is not adhered to peripheral surfaces of the gas diffusion electrodes (as shown in FIG. 5). Next, a sealing manufacturing procedure the same as that of Example 1 is performed to obtain the flexible sealing structure (cell) of Comparative Example 2.

A sealing air leakage and electrode electric power test is performed for a flexible stack-up structure (cell) in Example 1, Example 2, Comparative Example 1 and Comparative Example 2. A test method is as follows.

### Cell and Runner Plate Assembly

For the detection of the cell performance, the cell and runner plate of each embodiment are assembled, and the electric property of the cell is tested by introducing fuel gas.

Referring to FIG. 2, FIG. 4 and FIG. 6 together, generally, a high-temperature-resistant rubber gasket 24 is configured to support a runner plate 20 and fixe and seal a periphery of the cell. A runner plate 20 is in contact with the electrode gas diffusion layer of the flexible sealing structure 10 (cell) to conduct electrons and introduce air or hydrogen gas into an electrode gas runner 22, respectively. An edge end of the electrode gas runner 22 is aligned with an edge of the hollow region of the flexible sealing member for compression assembly to form an elementary cell pack. When the fuel gas is introduced, fuel can be concentrated in the electrode gas diffusion layer to improve the cell performance, and the electrolyte membrane cannot easily leak electrolyte liquid under high-temperature operation, and bending and compression. The runner plate 20 is, for example, made of a flexible high-temperature-resistant rubber material, and is in contact with a portion of the first surface 201a and a portion of the second surface 201b of the membrane electrode assembly, a surface 20a of the runner plate 20, near the flexible sealing structure 10 (cell) includes a gold plating collector layer (not shown). It is worth mentioning that interface between the runner plate 20, the flexible sealing structure 10 (cell) and the high-temperature-resistant rubber gasket 24 has flexibility due to the existence of a buffer space 26.

### Sealing Gas Leakage Test

Firstly, the cell is heated to 160° C., a leakage test is performed for the membrane electrode assembly, and the cell is tested under the condition of maintaining nitrogen gas supply. In the test, a pressure of the leakage test is 28 psi, and a leakage rate of the cell of each embodiment is measured. Additionally, a flexibility test is performed for the cell of Example 1. For the flexibility test, a cell sealing gas leakage test is performed after the cell is folded for 1000 times at a folding radius of 10 mm.

### Cell Electric Power Test

Firstly, the cell in each embodiment is activated according to the following activation steps: (1) in an OCV state, hydrogen gas is introduced at 200 c.c./min from an anode end, air is introduced at 500 c.c./min from a cathode end, and a temperature of the cell is raised to 120° C.; (2) after the temperature of the cell reaches 120° C., a certain current of 200 mA/cm² is loaded, and the temperature of the cell is continuously raised to 180° C.; (3) after the temperature of the cell reaches 180° C., a flow rate of reaction gas is changed into an equivalence ratio of 1.2 (hydrogen gas) to 2 (air); and (4) continuous operation is carried out for 24 hours to 72 hours until a voltage of the cell reaches a stable state.

After the cell is activated, under the operation condition of the temperature between 140° C. and 180° C., the hydrogen gas and the air (at a dose ratio of about 1:2) are introduced. Additionally, in order to accelerate an aging test, the gas flow rate is improved to 3 times of a standard flow rate. That is, the test conditions include the hydrogen gas of 1500 sccm, the air of 3000 sccm, an operation temperature of 160° C. and a constant voltage of 0.6 V. Under such conditions, a current value of the cell of each embodiment is measured.

In addition, a long-time effectiveness test is performed on the cell. The cell is operated at a high temperature of 160° C. or higher (160° C. to 180° C.) for at least 200 h, and a voltage reduction amplitude of the cell of each embodiment is measured at a current value of 0.2 A/cm².

The sealing air leakage and electrode electric power test results of the flexible stack structure (cell) of each embodiment are shown in Table 3 below.

TABLE 3

| | | | | Comparative | Comparative |
|---|---|---|---|---|---|
| | Example 1 | | Example 2 | Example 1 | Example 2 |
| Assembly of membrane | Even side surface | | Even side surface | Uneven side | Uneven side |
| electrode assembly | | | | surface | surface |
| Flexibility test at | 1000 times | — | — | — | — |
| folding radius of 10 | | | | | |
| mm | | | | | |
| Air leakage test of | 13 | 12 | 112 | 54 | 162 |
| cell at pressure of | | | | | |
| 28 psi (cc/m) | | | | | |
| Open circuit | 0.931 | 0.945 | 0.7 | 0.936 | 0.3 |
| voltage at 160° C. | | | | | |
| (V) | | | | | |
| Instant maximum | 356 | 401 | 135 | 288 | 0 |
| electric power | | | | | |
| density at 160° C. | | | | | |
| (mW/cm²) | | | | | |
| 0.6 V current | 312 | 295 | 88 | 240 | 0 |
| density at 160° C. | | | | | |
| (mA/cm²) | | | | | |
| Voltage reduction | 200 h < 2% | 200 h < 2% | 40 h > 30% | 40 h > 30% | — |
| amplitude of 0.2 | | | | | |
| A/cm² long-time | | | | | |
| effective test at | | | | | |
| 160° C. (%) | | | | | |

It can be known from Table 3 that the measured cell leakage rate of the cell in Example 1 is 12 cc/m, after the repeated folding, the measured cell leakage rate is 13 cc/m. That is, the gas leakage rate of the cell has no obvious change after the flexibility test. In the electrode electric power test, the current values of the cell of Example 1 measured before and after the flexibility test are respectively 295 mA/cm² and 312 mA/cm², and in the 200-hour long-time effective test, the voltage reduction amplitudes of the cell measured before and after the flexibility test are both smaller than 2% based on an initial voltage. That is, the sealing performance and the flexibility of the cell of Example 1 are favorable. However, in Comparative Example 1, the measured cell leakage rate of the cell is 54 cc/m, in the electrode electric power test, the current value of the cell is only 240 mA/cm², in the long-time effective test, the measured voltage reduction amplitude of the cell in 40 hours exceeds 30% based on the initial voltage (reduced from 0.64 V to 0.44 V). That is, the cell in Comparative Example 1 has a gas leakage phenomenon, and has poor sealing performance. In Comparative Example 2, the measured cell leakage rate of the cell is 162 cc/m, at the operation temperature of 160° C., mutual influence of gas at two sides is caused by electrolyte membrane cracking, the open circuit voltage is only 0.3 V, and no electric power is output.

In addition, it can be known from Table 3 that the cell sealing gas leakage and electrode electric power test results of Example 1 are better than that of the cell of Example 2. That is, the flexible sealing member of the invention has favorable sealing performance and flexibility than a sealing member made of a conventional material. Therefore, the membrane electrode assembly (an even side surface assembly structure) of the invention matched with the flexible sealing member of the invention can reach favorable sealing performance.

In addition, as shown in FIG. 7, the appearance of a finished product obtained after the flexible sealing structure of Example 1 is packaged is bendable, which is suitable for a roll-to-roll continuous manufacturing process. That is, the flexible sealing member and the flexible sealing structure of Example 1 have a certain mechanical intensity, so that the membrane electrode assembly can be protected, and the separation of each layer structure of the membrane electrode assembly can be prevented. As shown in FIG. 8 that shows edges and corners of the finished product of the flexible sealing structure in Example 1, the packaged finished product has flat sealing turning positions, and has no bubbles or no uneven conditions.

In addition, as shown in FIG. 9, the electrolyte membrane of the uneven side surface electrode assembly contains electrolyte liquid, so that the electrolyte liquid easily leaks when the cell is prepared at the above temperature and pressure. Therefore, after the sealing by the flexible sealing member, bubbles or creases that cannot be tightly sealed are liable to occur in the turning position or the edge position of the membrane cell assembly, which leads to surface unevenness of the flexible sealing member, or even sealing performance reduction.

Based on the above, in the flexible sealing structure (cell) of the invention, the membrane electrode assembly is a structure assembled in the even side surface mode, and is easy to process and align, and suitable for mass production. After the stack-up membrane electrode assembly is sealed with the flexible sealing member, the gas or electrolyte seepage can be effectively prevented, so that the formed flexible sealing structure has high battery performance and durability. Otherwise, in the structure assembled in the uneven side surface mode, the problems of increase of required sealing film area range, alignment processing difficulty, gas and electrolyte leakage and the like are obvious.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. A flexible sealing structure, comprising:
a flexible sealing member, comprising a first flexible sealing film and a second flexible sealing film, wherein a hollow region is formed in a center of the flexible sealing member; and
a membrane electrode assembly, located between the first flexible sealing film and the second flexible sealing film, wherein a side surface of the membrane electrode assembly is even, the membrane electrode assembly comprises a first surface and a second surface, and the hollow region of the flexible sealing member exposes a portion of the first surface and a portion of the second surface of the membrane electrode assembly.

2. The flexible sealing structure according to claim 1, wherein the hollow region of the flexible sealing member exposes 80% to 95% of the first surface and 80% to 95% of the second surface of the membrane electrode assembly.

3. The flexible sealing structure according to claim 1, wherein the two flexible sealing films are adhered to an edge of the first surface and an edge of the second surface of the membrane electrode assembly.

4. The flexible sealing structure according to claim 1, wherein the membrane electrode assembly sequentially comprises a first electrode gas diffusion layer, a first electrode catalyst layer, an electrolyte membrane layer, a second electrode catalyst layer, and a second electrode gas diffusion layer in a direction from the first surface to the second surface.

5. The flexible sealing structure according to claim 1, wherein each of the first flexible sealing film and the second flexible sealing film comprises a polymer layer and a thermosetting resin layer, the thermosetting resin layer of the first flexible sealing film is arranged near the first surface of the membrane electrode assembly, and the thermosetting resin layer of the second flexible sealing film is arranged near the second surface of the membrane electrode assembly.

6. The flexible sealing structure according to claim 1, wherein thermosetting resin layers of the first flexible sealing film and the second flexible sealing film are opposite to be thermally bonded to each other.

7. The flexible sealing structure according to claim 6, wherein peripheries of the thermosetting resin layers of the first flexible sealing film and the second flexible sealing film are opposite to be thermally adhered to each other.

8. The flexible sealing structure according to claim 1, wherein a thickness of a thermosetting resin layer of each of the first flexible sealing film and the second flexible sealing film ranges between 25 μm and 300 μm.

9. The flexible sealing structure according to claim 1, wherein a thickness of a polymer layer of each of the first flexible sealing film and the second flexible sealing film ranges between 5 μm and 50 μm.

10. The flexible sealing structure according to claim 1, wherein a thickness of the membrane electrode assembly ranges between 200 μm and 1,000 μ.
